(19) United States
(12) Patent Application Publication
(10) Pub. No.: US 2006/0045973 A1
(43) Pub. Date: Mar. 2, 2006

(54) Paint shield

(76) Inventor: Kerry Hann, Ashland, MA (US)

Correspondence Address: DALY, CROWLEY, MOFFORD & DURKEE, LLP, SUITE 301A, 354A TURNPIKE STREET, CANTON, MA, 02021-2714, US

(21) Appl. No.: 10/925,156

(22) Filed: Aug. 24, 2004

(51) Int. Cl. B05C 11/11; B05D 1/32

(52) U.S. Cl. 427/282; 118/504; 118/505; 118/506

(57) ABSTRACT

A paint shield covers an area that should not be painted. The paint shield can be quickly extended and placed in a desired position as part of the paint preparation process. In another embodiment, the paint shield can be compressed and placed within a opening, such as for a window.

### CROSS REFERENCE TO RELATED APPLICATIONS

Not Applicable.

### STATEMENT REGARDING FEDERALLY SPONSORED RESEARCH

Not Applicable

### FIELD OF THE INVENTION

The present invention relates generally to painting and, more particularly, to devices for shield for painting.

### BACKGROUND OF THE INVENTION

As is well known in the art, painting large structures, such as houses, is significant undertaking. To increase the overall efficiency of the project, a great deal of time is spent preparing the house or structure for an application of paint. For example, especially when spraying paint, windows, doors and the like should be covered to prevent paint intended for the exterior wall from reaching the windows and doors. As will be appreciated by one of ordinary skill in the art, covering and protecting surfaces that should not be painted is quite time consuming.

It would, therefore, be desirable to decrease the time required to prepare a structure to be painted.

### SUMMARY OF THE INVENTION

The present invention provides a device to quickly cover predetermined areas to prevent the undesired application of paint when painting adjacent areas. With this arrangement, the preparation time for a house to be painted is decreased so that the overall painting process efficiency is enhanced.

In one embodiment, a paint shield device includes a first member overlapping with a second member and a bias member coupled to the first and second members. In an exemplary embodiment, the first and second members are generally flat and somewhat rigid. A bias member biases the first and second members to a first amount of overlap at a non-use position and against a second amount of overlap less than the first amount. With this arrangement, the first and second members can be separated to some extent and secured by the bias member across a door or window for example.

In another embodiment, a paint shield device includes first and second members and a bias member secured to the first and second members. The device is well-suited for placement inside an opening to cover a window, for example. To position the device inside a window opening, the first and second members are forced together to increase an amount of overlap. Upon release, the bias member pressures the first and second members against window opening. Protruding members on the first and/or second member can enable a user to pull the device out of the window opening.

### BRIEF DESCRIPTION OF THE DRAWINGS

The invention will be more fully understood from the following detailed description taken in conjunction with the accompanying drawings, in which:

FIG. 1 is a pictorial representation of a paint shield in accordance with the present invention secured to a structure in a use position;

FIG. 2 is a schematic depiction of an exemplary embodiment of a paint shield in accordance with the present invention;

FIG. 3 is a schematic depiction of a further embodiment of a paint shield in accordance with the present invention;

FIG. 4 is a schematic depiction of a still further embodiment of a paint shield in accordance with the present invention;

FIG. 5 is a schematic depiction of another embodiment of a paint shield in accordance with the present invention; and

FIG. 6 is a schematic depiction of a further embodiment of a paint shield in accordance with the present invention;

FIG. 7 is a schematic depiction of another embodiment of a paint shield in accordance with the present invention; and

FIG. 8 is a schematic depiction showing additional exemplary implementation details of the paint shield of FIG. 7.

### DETAILED DESCRIPTION OF THE INVENTION

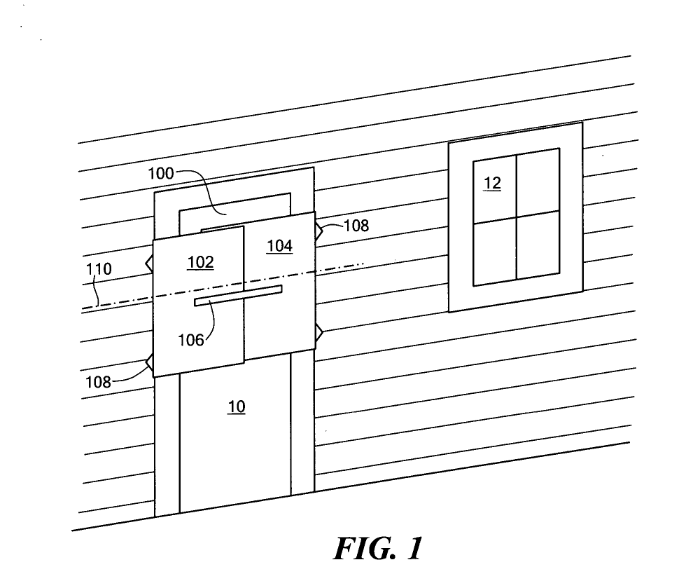

FIG. 1 shows a paint shield system 100 in accordance with the present invention. The system 100 is well-suited to cover areas, such as a door 10, window 12, etc., that should not be painted. Many types of such areas that should not be painted will be readily apparent to one of ordinary skill in the art.

In one embodiment, the system 100 includes substantially flat first and second members 102,104 that can reciprocate with respect to each other. A bias member 106 is secured to the first and second members 102, 104 to bias the first and second members in a desired position. The system 100 includes at least one gripping mechanism 108 secured to an edge or outer region of the first member 102 and at least one gripping mechanism 108 secured to an edge or outer region of the second member 104.

In operation, the paint shield system 100 is movable between a use position (shown) and a non-use position. In the non-use position, the first and second members 102, 104 are generally at a maximum overlap. In the use position, pressure is applied against the bias member 106 to separate the first and second members 102, 104 along an axis 110 to extend an area covered by the first and second members. The first and second members 102, 104 are moved to decrease the amount of overlap. At the desired separation, the opposing gripper mechanisms 108 can be applied to the desired locations to secure the paint shield in position.

For example, the first and second members 102, 104 can be separated to a length greater than a width of the door 10. A user can then place the paint shield system 100 across the door 10 so that the gripper mechanisms engage outer surfaces of a doorjamb, for example. The bias member 106 pressures the gripper mechanisms 108 against the door surfaces with a force that is sufficient to retain the paint shield system 100 in place.

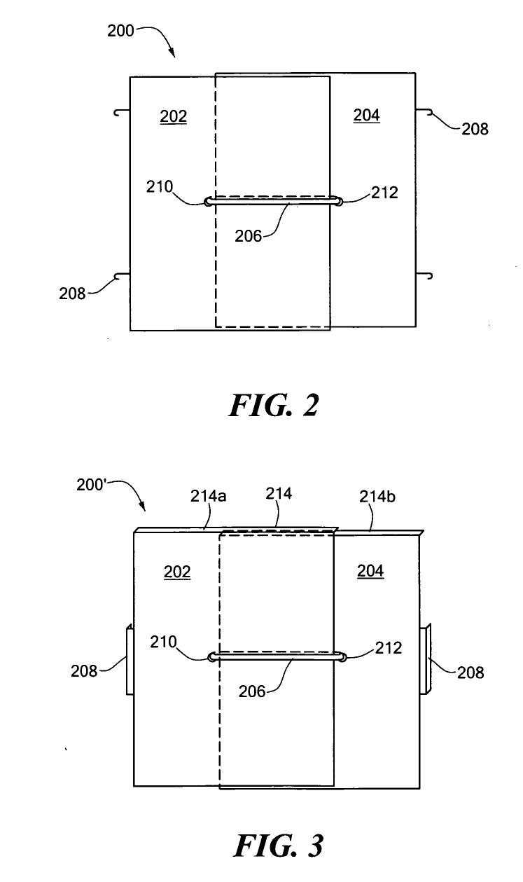

FIG. 2 shows an exemplary embodiment of a paint shield 200 in accordance with the present invention. The paint shield 200 includes reciprocating first and second members 202, 204 and an elastomeric bias member 206. The system further includes gripper mechanisms 206 in the form of hooks that can grip a surface.

In the illustrated embodiment, the first member 202 includes a first aperture 210 and the second member 204 includes a second aperture 212. In general, the first aperture 210 in the first member 202 is proximate an end of the second member 204 and the second aperture 212 in the second member 204 is proximate an end of the first member in the non-use position. The elastomeric bias member 206, here shown as a stretchable cord, is generally without tension in the non-use position.

As the first and second members 202, 204 are pulled apart to the use position, the bias member 206 is stretched and placed in tension. The resultant tension in the stretched cord of the bias member 206 pressures the hooks 208 into a surface so as to secure the paint shield in position.

FIG. 3 shows a further embodiment of a paint shield 200′ in accordance with the present invention. In addition to the features shown in the system 200 of FIG. 2, in which like reference designations indicate like elements, the paint shield 200′ includes an upper flap 214 to cover a surface, such as the top of a door jamb. The upper flap 214 includes a first portion 214a extending from the first member 202 and a second portion 214b extending from the second member 204. The first and second portions 214a,b overlap to form a continuous flap. In general, the first and second portions 214a,b should be of sufficient length to provide a continuous flap when the first and second portions 202, 204 are at maximum extension.

In another embodiment (not shown), further flaps extend from one or both of the first and second member ends. It is understood that a range of configurations are possible to extend the coverage ability of the paint shield device about its perimeter.

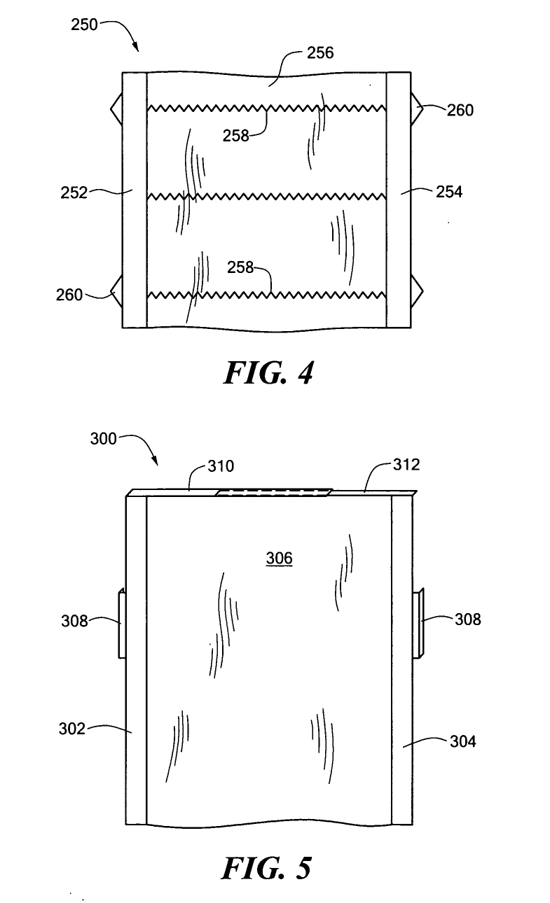

FIG. 4 shows another embodiment of a paint shield device 250 in accordance with the present invention. First and second rigid end members 252, 254 are coupled to a paint-blocking member 256. In one embodiment, the paint-blocking member 256 is not elastic. At least one bias member 258 extends from the first end member 252 to the second end member 254. Gripper mechanisms 260 can be secured to the first and second end members 252, 254.

Exemplary bias members include springs, elastic cords, and rubber bands. Illustrative elastic and inelastic materials for the paint-blocking member include canvas, urethane-based plastic, sheets having embedded elastic cords, and the like.

FIG. 5 shows a further embodiment of a paint shield 300 in accordance with the present invention. The paint shield 300 includes substantially rigid first and second end members 302, 304 secured to an elastomeric member 306. The paint shield 300 can further include gripper mechanisms 308 coupled to the first and second end members 302, 304.

In general, the first and second end members 302, 304 are pulled apart to stretch the elastomeric member 306 such that the elastomeric member pressures the gripper mechanisms against respective surfaces while in the use position.

The paint shield 300 can further include an optional top member 310 secured to the elastomeric member 306. The top member 310 can include a telescoping member 312 to optimize coverage at a top of the paint shield 300.

It is understood that the elastomeric member can be provided in a range of materials that are suitable to block paint and to generate sufficient pressure on the gripper mechanisms in the use positions. Suitable materials for the elastomeric member will be readily apparent to one of ordinary skill in the art. For example, the elastomeric member can include embedded elastics to provide a desired elasticity.

The first and second end members 302, 304 can be formed from a variety of well-known materials providing suitable rigidity. Exemplary materials include plastics, metals, and polymeric materials.

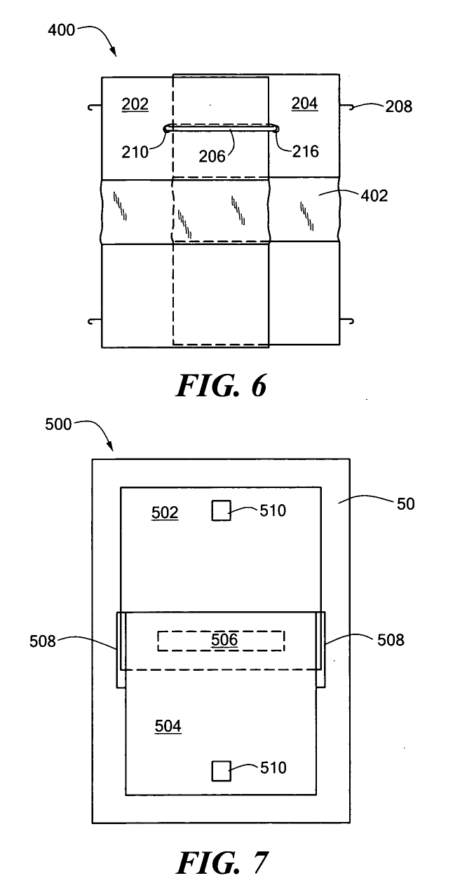

FIG. 6 shows a paint shield 400 having some features common with the paint shield 200 of FIG. 2 where like reference numbers indicate like elements. The first and second members 202′, 204′ include an extendable portion 402. In use, the first and second members 202′, 204′ can be separated and the device positioned to cover a door, for example, the extendable portion 402 allows the lower portions of the first and second members to drop due to gravity and thereby block and cover the door down to the ground.

It is understood that the extendable portion 402 of the first and second members 202′, 204′ can comprise any suitable area to provide the desired elasticity. In one embodiment, the extendible portion 402 is coupled to the bottom of the first and second members 202′, 204′. A weight coupled to the extendable portion 402 is effective to extend the extendible portion down to the ground. It is understood that the extendible portion 402 can be formed from a wide range of suitable elastic and inelastic materials.

FIG. 7 shows a paint shield device 500 that is suitable for placement inside a window frame 50, for example. In some structures, windows are recessed to some extent from a surface of an outer wall. The device 500 includes first and second members 502, 504 and a bias member 506. A guide 508 can maintain the first and second members in close proximity as the amount of overlap between the first and second members changes.

To secure the paint shield device 500 in position, the first and second members 502, 504 are pushed together to increase the amount of overlap and the device is placed within a window opening, for example. The bias member 506 biases the first and second members 502, 504 apart so as to force the first member against an upper portion of the window opening and to force the second member against a lower portion of the window opening. Protruding members 510 enable a user to easily pull the device out of the window opening after use.

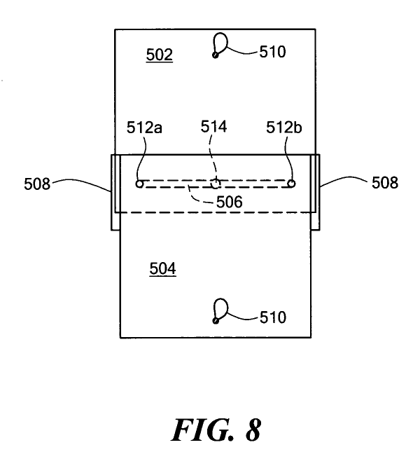

FIG. 8 shows an exemplary implementation of the paint shield device 500 of FIG. 7 in which like reference numbers indicate like elements. The bias member 506 includes an elastic cord secured to second member 504 at first and second locations 512a,b. In one embodiment, the first and second locations 512a,b are placed at opposing points on a perimeter of the second member. The cord 506 is also secured to the first member at a point 514 between the first and second locations 512a,b on the second member 504. It will be appreciated that the locations at which the cord is attached to the first and second portions can vary to meet the needs of a particular application.

When the first and second members 502, 504 are pushed together to place the device in a window opening, the cord is stretched so that the first and second members push against the window opening. Protruding members in the form of loops 510 can be pulled to remove the device from the window opening.

In general, the dimensions of the paint shield should be sized to cover a particular area. For example doors and windows typically have standard sizes to which the paint shield can be dimensioned for optimal performance. In addition, the height of the paint shield can be readily selected to meet the needs of a particular application. For example, a paint shield can have a height that substantially corresponds to that of a standard door height. In addition, while the invention is primarily shown and described in conjunction with exterior painting applications, it is understood that the invention is applicable to interior painting, painting and staining hobby projects, and applying materials to furniture.

It is understood that the various components described in the exemplary embodiments herein can be provided from a wide range of devices and parts. For example, suitable structures for the bias member include elastic cords, springs, rubber bands, stretchable fabrics, and the like. Accordingly, the term bias member should be construed broadly to include various items than can apply pressure. In addition, it will be appreciated that the bias member can be secured to the first and second members in a wide variety of ways to achieve a desired function without departing from the invention. Further, movement of first and second members can be guided by a wide range of suitable structures known to one of ordinary skill in the art including guides, rails, and the like.

Similarly, the gripper mechanism should be construed broadly to include structures that can facilitate securing the paint shield system to a desired position. Exemplary gripper mechanisms include high friction and textured surfaces, hooks, sharp protrusions, and the like.

It is further understood that the structure of the first and second members can vary. The first and second members can be provided having any suitable thickness and material that is suitable to block paint. Exemplary materials include plastic and cardboard of suitable rigidity. The first and second member can be formed from materials that are quite rigid as well as materials that are not rigid at all. Further, the term flat should not be construed to require any particular surface smoothness but rather merely to imply a length that is substantially more than a thickness.

In addition, embodiments are contemplated in which the gripper mechanisms are effective to secure the paint shield device to a structure independent from the bias member. Further, it is understood that bias member can be coupled to a perimeter component of the paint shield device without attachment to an interior member, such as a non-elastomeric sheet material.

The present invention provides a paint shield that is effective cover selected areas, such as doors and windows, while paint is applied to a structure. The paint shield can be quickly and easily placed in a desired position to reduce the paint preparation time. In addition to the concomitant convenience, professional painters will enjoy a commercial advantage from the reduced preparation and clean up time.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A paint shield device, comprising:
a first member;
a second member overlapping the first member;
a bias member coupled to the first and second members, the bias member to bias the first and second members to a first amount of overlap at a non-use position and to bias the first and second members against a second amount of overlap less than the first amount in a use position.

2. The device according to claim 1, further including a first gripper mechanism coupled to the first member and a second gripper mechanism coupled to the second member to secure the device in position in the use position.

3. The device according to claim 2, wherein the first gripper mechanism includes a hook.

4. The device according to claim 2, wherein the first gripper mechanism includes one or more of friction enhancing surfaces, textured surfaces, hooks, and sharp protrusions.

5. The device according to claim 1, wherein the bias member includes an elastomeric material.

6. The device according to claim 5, wherein the bias member includes an elastomeric cord.

7. The device according to claim 6, wherein the cord passes through the first member via a first aperture and through the second member via a second aperture.

8. The device according to claim 1, wherein the bias member includes one or more of an elastic cord, spring, rubber band, and stretchable fabric.

9. The device according to claim 1, further including a flap member generally perpendicular to the first member.

10. The device according to claim 1, wherein the first and second members are substantially rigid.

11. A paint shield device, comprising:
a bias member;
an expandable means coupled to the bias member, the expandable means to block paint after expansion to a use position from a non-use position; and
gripper means coupled to the expandable means to secure the device to a structure.

12. The device according to claim 11, wherein the expandable means includes first and second members that can reciprocate along an axis.

13. The device according to claim 11, wherein the gripper means includes one or more of friction enhancing surfaces, textured surfaces, hooks, and sharp protrusions.

14. The device according to claim 11, wherein the bias member includes one or more of an elastic cord, spring, rubber band, and stretchable fabric.

15. A paint shield device, comprising:
first and second end members;
an elastomeric member coupled between the first and second end members; and
a gripper mechanism coupled to the first and second end members, wherein the elastomeric member secures the gripper mechanism to a structure in a use position in which the elastomeric member is stretched.

16. The device according to claim 15, further including a paint-blocking member extending between the first and second end members.

17. A method of covering an area adjacent an area to be painted with a paint shield device, comprising:
decreasing an amount of overlap between first and second overlapping members coupled by a bias member; and
positioning gripper mechanisms coupled to the overlapping members to secure the device to a structure in a use position in which the bias member pressures the gripper mechanisms against respective surfaces.

18. The method according to claim 18, wherein the adjacent area is a door.

19. A paint shield device, comprising:
a first member;
a second member overlapping the first member;
a bias member coupled to the first and second members, the bias member to bias the first and second members to a first amount of overlap at a non-use position and to bias the first and second members against a second amount of overlap more than the first amount in a use position.

20. The device according to claim 19, wherein the bias member includes an elastomeric material.

21. The device according to claim 19, wherein the first and second members are generally flat.

22. The device according to claim 21, wherein the first and second members are at least semi-rigid.

23. The device according to claim 19, wherein the bias member includes an elastic cord coupled to the first and second members.

24. The device according to claim 19, further including one or more protrusions coupled to the first member and/or the second member to facilitate removal of the device from a use position.
